(19) United States
(12) Patent Application Publication
(10) Pub. No.: US 2014/0091803 A1
(43) Pub. Date: Apr. 3, 2014

(54) SYSTEMS FOR AND METHODS OF MONITORING UNDERGROUND CO2 STORAGE

(71) Applicants: Kevin Dodds, Houston, TX (US); Charles Christopher, Houston, TX (US)

(72) Inventors: Kevin Dodds, Houston, TX (US); Charles Christopher, Houston, TX (US)

(73) Assignee: BP CORPORATION NORTH AMERICA INC., Houston, TX (US)

(21) Appl. No.: 13/633,939

(22) Filed: Oct. 3, 2012

(51) Int. Cl. G01V 3/18; B65G 5/00

(52) U.S. Cl. 324/351; 405/129.5

(57) ABSTRACT

In accordance with aspects of the present disclosure, techniques for monitoring subterranean sequestered CO₂ are disclosed. Tools for gathering relevant data are disclosed, and techniques for interpreting the resultant data also disclosed. For example, electrodes and micro-gravity sensors may be deployed, and their readings interpreted to detect underground CO₂ migration.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Carbon dioxide (CO₂) is a byproduct of many industrial processes. In some cases, there is a desire to sequester quantities of CO₂ in a manner that prevents it from entering the atmosphere. Sequestration of CO₂ underground is one possibility. When sequestering CO₂ underground, it is sometimes desirable to determine if the CO₂ has migrated from its initial location. For example, it is sometimes desirable to determine whether CO₂ has migrated to underground sources of drinking water.

### BRIEF SUMMARY

In accordance with some aspects of the present disclosure, a method of monitoring storage of CO₂ in an underground formation is disclosed. The method can include establishing underground electrodes configured to monitor an electrical property of at least a portion of the formation and establishing underground micro-gravity sensors configured to monitor a density of at least a portion of the formation. The method can also include determining a baseline electrical property of at least a portion of the formation and determining a baseline density of at least a portion of the formation. The method can further include injecting CO₂ into the formation. The method can further include determining an updated electrical property of at least a portion of the formation and determining an updated density of at least a portion of the formation. The method can further include monitoring the underground electrodes and monitoring the underground microgravity sensors. The method can further include detecting a change in the electrical property of at least a portion of the formation and a change in density of at least a portion of the formation, wherein the change in the electrical property and the change in density are indicative of CO₂ migration.

### BRIEF DESCRIPTION OF THE DRAWINGS

FIG. 1 is a schematic diagram representing electrode placement according to an embodiment.

FIG. 2 is an example chart depicting admittance versus gas saturation according to an embodiment.

FIG. 3 is a schematic diagram representing micro-gravity sensor placement according to an embodiment.

FIG. 4 is an example chart depicting depth versus gravitational change according to an embodiment.

FIG. 5 is a flowchart depicting an example method according to an embodiment.

### DETAILED DESCRIPTION

CO₂ can be sequestered underground by injecting it into pre-existing boreholes, boreholes drilled specifically for the purpose of CO₂ storage, or both. CO₂ can be sequestered in compressed form at the surface prior to injection. CO₂ is typically injected into a relatively permeable layer of a geological sub-surface formation that lies beneath one or more relatively impermeable layers. CO₂ may be sequestered, for example, 4000-10,000 feet (about 1200-3048 meters) underground. This process is sometimes known as “carbon sequestration” within a technological methodology known as “carbon capture and storage”

Embodiments allow for monitoring subterranean CO₂ storage. In particular, embodiments allow for monitoring whether sequestered CO₂ has migrated vertically or horizontally underground subsequent to its injection into a subterranean storage location.

As disclosed herein, a combination of electrical and micro-gravity sensors may be used to monitor whether CO₂ sequestered underground has migrated from its initial storage location. The combined sensor types provide a synergy that allow for monitoring both vertical and horizontal CO₂ displacement. Sensor placement and interpretation of data gathered by the installed sensors are discussed in detail herein as follows.

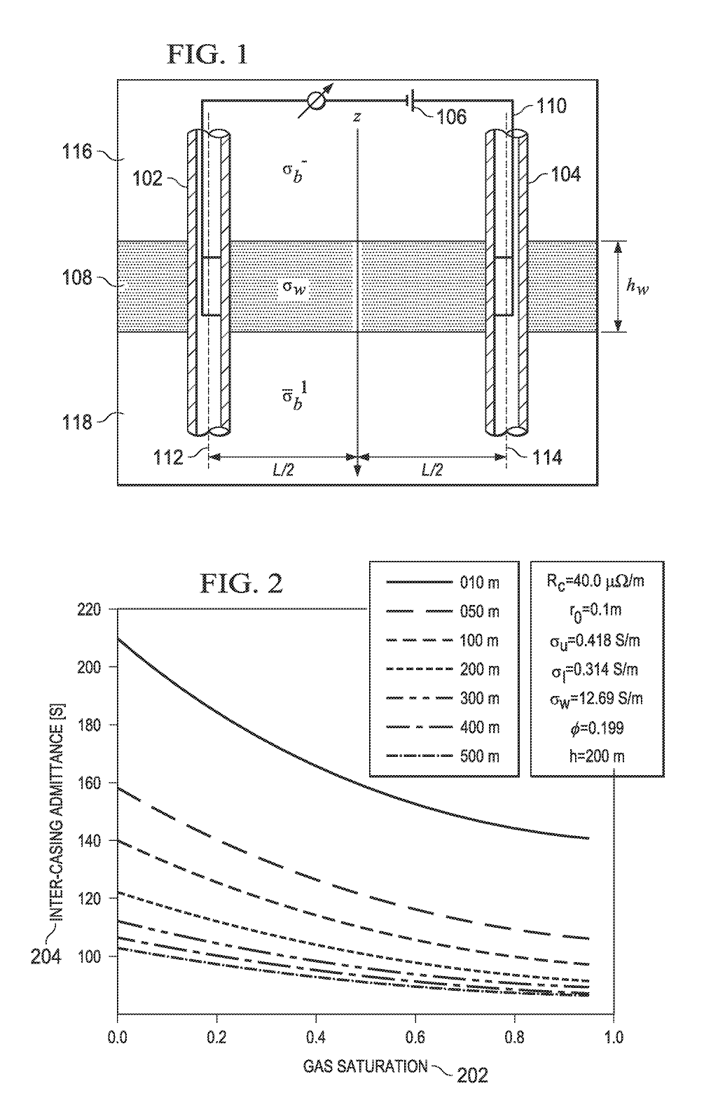

FIG. 1 is a schematic diagram representing exemplary electrode placement according to an embodiment. According to certain embodiments, displacement of sequestered CO₂ is detected by monitoring changes in electrical current flow between sub-surface electrodes. FIG. 1 illustrates a schematic representation of two electrodes formed by borehole metallic casings 102, 104. In general, boreholes 112, 114, such as those used to extract petroleum and those used to inject CO₂, may be reinforced using metallic casings. Because such casings are typically highly conductive and subterranean, they can provide efficient preexisting electrodes for detecting underground CO₂ migration.

According to certain embodiments, borehole casing electrodes 102, 104 may be selected such that boreholes 112, 114, and thus casing electrodes 102, 104, are separated by a horizontal distance L (depicted in FIG. 1 as the sum of L/2 and L/2), which may be less than that of the depth of the underground CO₂ plume in the sequestration target zone 108. Conductive wires 110 may be connected to power source 106 and inserted into boreholes 112, 114 such that they make electrical contact with metallic casings 102, 104 at a depth interval at least as great as the borehole separation L. That is, the distance from the surface to the electrical contact may be at least as great as the distance between boreholes 112, 114.

Parameters identified in FIG. 1 and referred to below in reference to FIG. 2 include the following. Sequestration target zone 108 has height h_{w} and a fluidic conductivity denoted by σ_{w}. The z-axis runs vertically in FIG. 1. The formation layer 116 above sequestration target zone 108 has a conductivity denoted by σ_{b}⁻, and the formation layer 118 below sequestration target zone 108 has a conductivity denoted by σ_{b}⁺.

FIG. 2 is an example chart depicting electrical admittance (i.e., the reciprocal of the electrical impedance) versus gas saturation according to an embodiment. The chart depicted in FIG. 2 may represent inter-electrode admittance of the system depicted schematically in FIG. 1.

In general, conductivity of sedimentary rocks may be represented according to, by way of non-limiting example:

σ=ασ_{W}S_{W}ⁿΦ^{m} Equation 1

In Equation 1, the term σ represents conductivity, Φ represents rock porosity, S_{W}=1−S_{G}, where S_{G} represents gas saturation, parameter α and cementation factor m vary from 0.6 to 1.5 and from 1.3 to 3, respectively, and saturation exponent n is close to 2.

Notably, electrical conductivity of rock is highly sensitive to gas saturation. For example, if gas saturation were to vary from 0.0 to 0.95, rock conductivity may vary by as much as a factor of 400.

To estimate inter-casing admittance versus gas saturation as illustrated by FIG. 2, the following non-limiting assumptions are made regarding the system depicted schematically in FIG. 1. Porosity of sequestration target zone 108 is assumed to be φ=0.199. The half-spaces above 116 and below 118 sequestration target zone 108 are assumed to be σ_{b}⁻=0.418 Siemens/meter (S/m) and σ_{b}⁺=0.314 S/m, respectively. The parameter α is assumed to be 1, and the parameters n and m are both assumed to be 2. Sequestration target zone 108 is assumed to lie between 1800 and 2000 meters, such that h_{w}=200 meters. Fluid conductivity at the center of sequestration target zone 108 is assumed to be σ_{w}=12.69 S/m. Again, these assumptions are made for illustrative purposes only; one of ordinary skill in the art is fully capable of adapting the example quantities and computations discussed herein to embrace particular situations encountered in the field.

Inter-casing admittance as illustrated in FIG. 2 and calculated for the system of FIG. 1 according to the exemplary parameters discussed herein may be represented according to, by way of non-limiting example:

Y=Y_{σ}_{_{b}}⁻+Y_{w}+Y_{σ}_{_{b}}⁺ Equation 2

In Equation 2, the first and last terms represent contributions of the half-spaces above and below sequestration target zone 108, respectively. The second term represents admittance of the sequestration target zone itself, which may be estimated according to, by way of non-limiting example:

Y_{w}=πS_{w}[F_{α}(L,0)−F_{α}(r₀,0)]⁻¹ Equation 3

In Equation 3, F_{α}(r,z)=2πH₀[exp−k|z|/(k+α), α=(σ_{b}⁺+σ_{b}⁻)/S_{w}, S_{w}=σ_{w}h_{w}, r is radial distance, and H₀[·] denotes a 0-order Hankel transform. The admittance of a conducting half-space penetrated by a semi-infinite casing (an appropriate assumption made here) may be estimated according to, by way of non-limiting example:

Y_{σ}_{_{b}}=0.25[Ψ_{σ}_{_{b}}(L,z=0)−Ψ_{σ}_{_{b}}(r₀,z=0)]⁻¹ Equation 4

In Equation 4, the term Ψ_{σ}_{_{b}} (r,z) may be defined according to, by way of non-limiting example:

$${Ψ}_{{σ}_{b}} ( r , z ) = \frac{1}{2 {π}^{2}} {\int }_{0}^{∞} \frac{{K}_{0} ( ξ r / {r}_{0} )}{Δ r {σ}_{s} {ξ}^{2} {K}_{0} ( ξ ) + {r}_{0} {σ}_{b} ξ {K}_{1} ( ξ )} cos ( \frac{z ξ}{{r}_{0}} ) d ξ \qquad Equation 5$$

In Equation 5, Kₙ(·) is the modified Bessel function of the second kind and of the n-th order.

The above equations and assumptions were used to generate the diagram of FIG. 2, which plots gas saturation 202 against inter-casing admittance 204 for the system described schematically in FIG. 1. The curves represented in FIG. 2 represent inter-casing separations L of 10 meters, 50 meters, 100 meters, 200 meters, 300 meters, 400 meters and 500 meters. Using this disclosure, one of ordinary skill in the art can place electrodes in borehole casings and be able to estimate the corresponding gas saturation in sequestration target zone 108 based on observed inter-casing admittance.

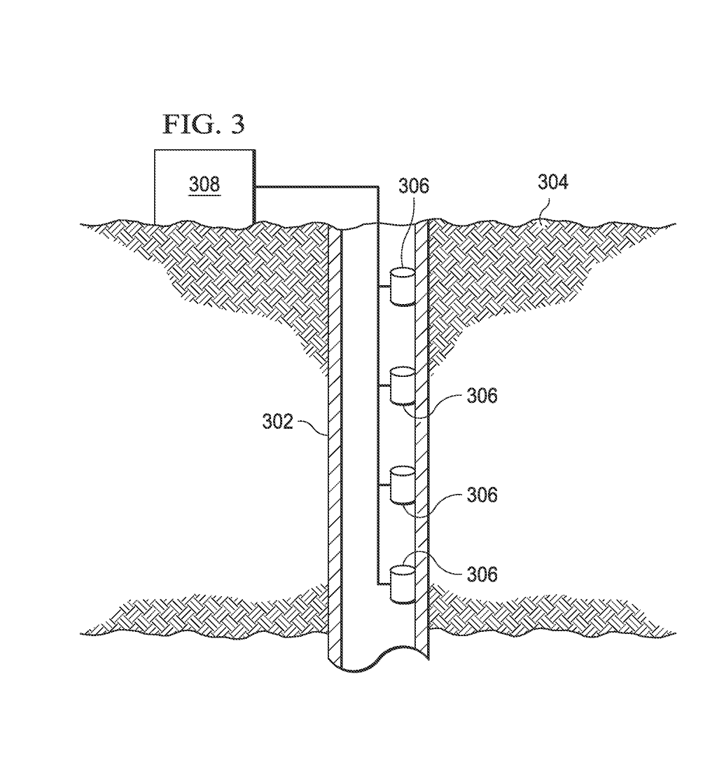

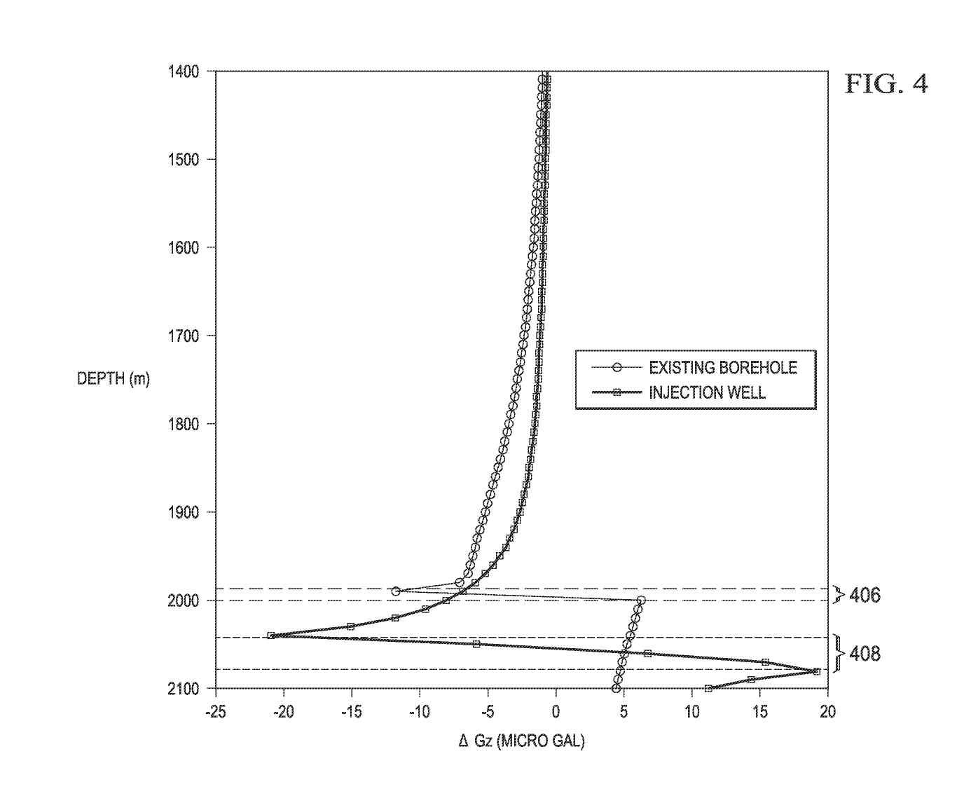

In addition to estimating gas saturation based on electrical admittance measurements, a component of certain embodiments includes estimating gas saturation based on density measurements made by micro-gravity sensors. This second component is discussed presently in reference to FIGS. 3 and 4.

FIG. 3 is a schematic diagram representing micro-gravity sensor placement according to an embodiment. In particular, FIG. 3 depicts borehole 302 below surface 304. Micro-gravity sensors 306 can be spaced along borehole 302 at 10 meter intervals. In some embodiments, micro-gravity sensors 306 can be spaced at 5 meter intervals within the sequestration target zone, and at 25 meter intervals above and below the sequestration target zone. In some embodiments, a single micro-gravity sensor is positioned in each borehole in the sequestration target zone (e.g., 108 of FIG. 1); in other embodiments, multiple (e.g., up to several dozen) can be placed both in and out of the sequestration target zone.

Micro-gravity sensors 306 can be placed in a network of multiple boreholes. In some embodiments, the boreholes are positioned in a square grid arrangement. Boreholes may be spaced at, by way of non-limiting example, 20 meter intervals, 100 meter intervals, or at other intervals.

The micro-gravity sensor placement parameters discussed herein are representative but non-limiting; other micro-gravity sensor placements are contemplated.

Micro-gravity sensors 306 are communicatively coupled to computing device 308. Computing device 308 may detect and store readings from micro-gravity sensors 306 continuously, at periodic intervals, or upon command. Example periodic intervals include daily, weekly, monthly, and quarterly.

An exemplary micro-gravity sensor is the Deep Density Borehole Gravity Meter (BHGM), available from Micro-g LaCoste, Inc. of Lafayette, Colo. In general, micro-gravity sensors 306 may be capable of resolutions on the order of 1 μGal.

FIG. 4 is an example chart depicting depth 404 versus gravitational change 402 according to an embodiment. The chart depicted in FIG. 4 illustrates changes in gravity subsequent to CO₂ injection into the sequestration zone as compared to gravity prior to injection. In general, the presence of CO₂ in a fluid alters the density of the fluid. As CO₂ replaces water in a formation, the density may decrease. On the other hand, as supercritical CO₂ replaces hydrocarbons in a formation, the density may increase.

In general, changes of at least one micro Gal indicate a movement of CO₂ into or out of the region that experienced the change. Changes that are within the noise threshold of the sensor (e.g., less than one micro Gal) may be disregarded. (As sensor technology advances and sensors become capable of detecting lower and lower differences in gravity, the one micro Gal threshold may be reduced.)

Two different boreholes are represented in FIG. 4: an existing borehole and a nearby borehole used as the CO₂ injection well. The CO₂ plume corresponding to the existing borehole lies at approximately 1990-2000 meters below the surface as shown at portion 406 of the graph, and the CO₂ plume corresponding to the injection well lies at approximately 2050-2085 meters below the surface as shown at portion 408 of the graph. The curves represent the difference in vertical attraction due to gravity by subtracting the gravitational response as observed before and after injection of the CO₂. For both boreholes, a decrease in vertical gravity is observed at the top of the reservoir. This is because the net density in the reservoir is negative since CO₂ is less dense than the water it has replaced, so the vertical gravitational force is negative. An increase in net gravity acceleration is observed below the reservoir. This is because the net density is negative above the sensor giving rise to a polarity change in acceleration measured.

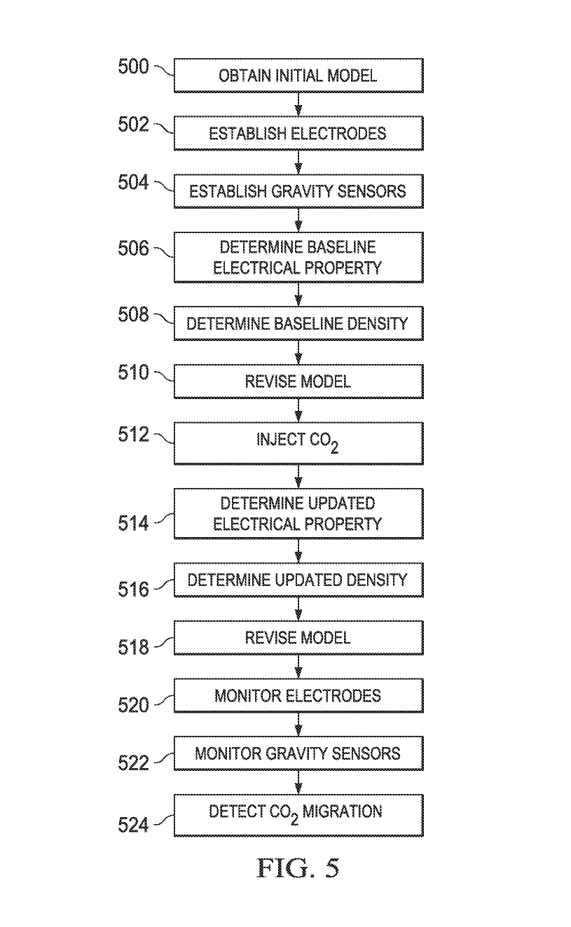

FIG. 5 is a flowchart depicting an example method according to an embodiment. At block 500 an initial model is obtained. The model under discussion represents the subterranean structure of the sequestration target zone and surroundings. It typically depicts the various sedimentation and other layers of geological or sequestration significance and their associated electrical and density properties. The initial model may be obtained using, by way of non-limiting example, seismic surveys employing reflective seismology and the electrical and density properties can be obtained by well log or core measurements from nearby wells.

At block 502, electrodes are established. This step is discussed in detail above in reference to FIGS. 1 and 2. At block 504, gravity sensors are established. This step is discussed above in reference to FIGS. 3 and 4.

At block 506, a baseline electrical property is established. This step occurs prior to CO₂ injection. The electrodes discussed in reference to block 502 may be used to that end. The electrical property may be, by way of non-limiting example, a measure of resistivity or admittance.

At block 508, a baseline density is established. Again, this step occurs prior to CO₂ injection. The micro-gravity sensors discussed above in reference to block 508 may be used for that purpose. The baseline density may reflect or be derived from micro-gravity readings.

At block 510, the initial model is revised. The revision may take into account the baseline electrical property and density readings obtained at blocks 506 and 508. In some embodiments, the initial model is revised by performing an inversion of the model, known to those of skill in the art. In such an inversion, empirical data may be used to back-calculate parameters of the model. The inversion may utilize the baseline density data, the baseline electrical property data, or both (e.g., a braid or “joint” inversion). It will be appreciated herein and throughout the disclosure, that other types of sensors, for example seismic sensors, can be utilized in the readings obtained. For example, readings including one or more of seismic electrical and seismic density. Then, electrical density and seismic electrical and density joint inversions can be performed.

At block 512, CO₂ is injected. This process may proceed over a time period that may span days or months. An exemplary, non-limiting injection rate is two kilograms per second. Other injection rates are also contemplated.

At block 514, an updated electrical property is obtained. The updated electrical property may be obtained as discussed above in reference to block 506. At block 516 an updated density is determined The updated density may be obtained as discussed above in reference to block 508.

At block 518, the model is revised. The model may be revised based on the updated electrical property obtained at block 514 and the updated density obtained at block 516. The updated model may be generated by way of inversion based on one or both of the updated electrical and density determinations. The revised model is intended to reflect the presence of sequestered CO₂. Furthermore, the revised model may be compared to the model obtained at block 510 in order to determine the geological differences caused by the new presence of sequestered CO₂. For example, the graph of FIG. 4 reflects such differences with respect to gravity.

At block 520, electrode readings are monitored, and at block 522 readings from the micro-gravity sensors are monitored. The monitoring may occur continuously, periodically, or on command. If periodically, the monitoring may occur daily, weekly, monthly, quarterly, or yearly. The data detected by the respective sensors may be stored electronically in persistent memory of a computer.

At block 524, CO₂ migration is detected. This may be performed by comparing the revised model obtained at block 518 to an inversion model based on the data obtained at blocks 520 and 522. Alternately, or in addition, the migration may be detected by detecting changes in the parameters themselves. Using both electrical properties and micro-gravity readings, the lateral and vertical extent of such migration may be ascertained.

Note that many of the steps recited herein may be automated using installed executable software. The software may be implemented on a computer, such as a personal computer executing an operating system.

While the present disclosure has been described according to its preferred embodiments, it is of course contemplated that modifications of, and alternatives to, these embodiments, such modifications and alternatives obtaining the advantages and benefits of this disclosure, will be apparent to those of ordinary skill in the art having reference to this specification and its drawings. It is contemplated that such modifications and alternatives are within the scope of this disclosure as subsequently claimed herein.

What is claimed is:

1. A method of monitoring storage of CO₂ in an underground formation, the method comprising:
establishing underground electrodes configured to monitor an electrical property of at least a portion of the formation;
establishing underground micro-gravity sensors configured to monitor a density of at least a portion of the formation;
determining a baseline electrical property of at least a portion of the formation;
determining a baseline density of at least a portion of the formation;
injecting CO₂ into the formation;
determining an updated electrical property of at least a portion of the formation;
determining an updated density of at least a portion of the formation;
monitoring the underground electrodes;
monitoring the underground microgravity sensors; and
detecting a change in the electrical property of at least a portion of the formation and a change in density of at least a portion of the formation, wherein the change in the electrical property and the change in density are indicative of CO₂ migration.

2. The method of claim 1, wherein the underground electrodes comprise at least one borehole casing.

3. The method of claim 1, wherein the change in density comprises the microgravity sensors detecting a change in excess of 1 μGal.

4. The method of claim 3, wherein the change in density comprises the microgravity sensors detecting a change in excess of 2 μGal.

5. The method of claim 1, wherein the change in density comprises an increase in density.

6. The method of claim 1, wherein the change in density comprises a decrease in density.

7. The method of claim 1, wherein the electrical property comprises admittance.

8. The method of claim 1, wherein the electrical property comprises resistivity.

9. The method of claim 1, further comprising obtaining a joint inversion model based on the baseline electrical property and the baseline density.

10. The method of claim 1, further comprising obtaining a joint inversion model based on the updated electrical property and the updated density.

11. A system for storage of CO₂ in an underground formation, the system comprising:
at least two underground electrodes disposed to monitor an electrical property of at least a portion of the formation;
a network of underground microgravity sensors disposed to monitor a density of at least a portion of the formation;
an electronic memory configured to store a baseline electrical property reading for at least a portion of the formation and a baseline density reading for at least a portion of the formation;
a channel configured to deliver CO₂ to the formation;
an electronic memory configured to store an updated electrical property reading for at least a portion of the formation and an updated density reading for at least a portion of the formation; and
a computer configured to detect a change in the electrical property for at least a portion of the formation and a change in density for at least a portion of the formation, wherein the change in the electrical property and the change in density are indicative of CO₂ movement.

12. The system of claim 11, wherein the underground electrodes comprise at least one borehole casing.

13. The system of claim 11, wherein the change in density comprises the microgravity sensors detecting a change in excess of 1 μGal.

14. The system of claim 13, wherein the change in density comprises a change in excess of 0.01 gm/cm².

15. The system of claim 11, wherein the change in density comprises an increase in density.

16. The system of claim 11, wherein the change in density comprises a decrease in density.

17. The system of claim 11, wherein the electrical property comprises admittance.

18. The system of claim 11, wherein the electrical property comprises resistivity.

19. The system of claim 1, further comprising a processor configured to generate an inversion model based on the baseline electrical property and the baseline density.

20. The system of claim 11, further comprising a processor configured to generate an inversion model based on the updated electrical property and the updated density.
